(19) United States
(12) Patent Application Publication
(10) Pub. No.: US 2020/0060221 A1
(43) Pub. Date: Feb. 27, 2020

(54) Litter Collection Device for Efficient Animal Waste Removal and Method Thereof

(71) Applicant: Petato Technology Limited, Hong Kong (CN)

(72) Inventors: Chao FAN, Hong Kong (HK); Xuran CHENG, Hong Kong (HK)

(21) Appl. No.: 16/112,918

(22) Filed: Aug. 27, 2018

(51) Int. Cl. A01K 1/01

(52) U.S. Cl. CPC A01K 1/011; A01K 1/0114

(57) ABSTRACT

A litter collection device for sifting animal waste using an improved sifting method is disclosed. The present invention provides a device comprising a device base and a chamber. The device base comprises a receptacle. The chamber located on the device base is filled with a litter material and receives the animal waste. The chamber is rotatable about an axis of rotation and further comprises a chamber opening and a partition. The chamber opening is operable as an ingress and an egress for the animal to deposit the animal waste, and is also operable as a waste opening for dumping the animal waste to the receptacle. The partition comprises screen sections and non-opening sections. The chamber is rotated such that the litter material passes through the screen sections and enters a trough, and the animal waste is kept out of the trough and dropped to the receptacle by the gravitational force.

### FIELD OF THE INVENTION

The present invention relates generally to a litter collection device for sifting animal waste, and more particularly, to an improved self-cleaning device that automatically separates animal waste from litter material efficiently.

### BACKGROUND

A potty device filled with litter material, such as sand, dried clay, or cat litter, can be used by pet animals to excrete waste. The litter material can give the pet animal a feeling similar to the outdoor environment when depositing bodily wastes thereon. In an effort to relieve pet owners from performing a highly unpleasant recurring task of cleaning the animal waste, such as animal excrement or coagulated litter, from the unsoiled litter material, various types of self-cleaning potty device are designed to separate animal waste automatically from the litter material for the ease of disposal. Typically, the self-cleaning potty device controls a motor in a manner to cause a separation device, such as rake, porous scoop, sifting screen, filtration grid, or sifting drawer, to drive through the lifter material and separate the animal waste from the litter material. The separated animal waste is then pushed to a waste collector, such as storage bag or waste compartment placed outside the chamber, for cleaning.

However, the conventional self-cleaning potty devices are usually structured with a chamber partially filled with litter material comprising at least two openings. The first opening provides an entrance and an exit for the pet animal, while the second opening is provided for accessing a waste collector outside the chamber whereby the waste material may be dropped into. Such conventional device with two openings has great disadvantages. When the device is sifting the waste material and dumping the waste material through the second opening, for example, by rotating the chamber to a predetermined position, the first opening is still accessible by pet animals. This poses a threat to the pet animal's safety as they may get injured by the moving parts. Furthermore, a chamber with two openings cannot provide sufficient space for a large opening as entrance or exit. If the pet animal is very tall, it will be very difficult for the pet animal to squeeze itself into the chamber.

In some automated potty devices, the chamber is not rotated but the separation device is movably mounted in the interior volume of the chamber. By a predefined movement of the separation device inside the chamber, the waste material is separated from the litter by the separation device. The drawback of this apparatus is that it requires a complicated design effort in order to ensure the effectiveness of the separation device at every corner of the chamber. The movable parts of the separation device inside the chamber can trap small material. Clumps of waste material or litter material can be wedged and built-up within the separation device. As a result, the separation device or other moving parts inside the chamber may be clogged or jammed and the waste can easily be accumulated therein, causing odor and unpleasant smells. More pet owner manual interactions are required to remove the waste material trapped inside the separation device, which is not a pleasant experience for the pet owner.

Accordingly, there is a need in the art to develop a lifter collection device for separating animal waste using an improved sifting method for filtering the animal waste without posing any danger to the pet animals. It would be preferred for the device to have a chamber with adequate interior space for pet animals so that they can move around when inside staying the device, and an entry opening that is large enough for pet animals of taller size to poke their head out vertically from the opening of the chamber without being obstructed. It would also be preferred for the device to have means for sanitizing the air inside the device and contain or control the unpleasant odors from the animal waste. Furthermore, other desirable features and characteristics will become apparent from the subsequent detailed description and the appended claims, taken in conjunction with the accompanying drawings and this background of the disclosure.

### SUMMARY OF THE INVENTION

It is an object of the present disclosure to provide a device for sifting animal waste from litter material and dumping the animal waste to a receptacle.

It is also an object of the present disclosure to provide a device having one chamber opening operable as an ingress and an egress for an animal, and also operable as a waste opening for dumping the animal waste to the receptacle.

It is a further object of the present disclosure to provide a device having a chamber opening that is sufficiently large enough for pet animals of taller size to poke their head out vertically from the chamber opening without being obstructed.

According to at least one aspect of the present disclosure, there is provided a device for handling an animal waste deposited by an animal, the device comprising a device base and a chamber. The device base comprises a receptacle, and the chamber is located on the device base for receiving the animal waste. The chamber containing a litter material is rotatable about an axis of rotation and comprises a chamber opening and a partition. When the chamber is in a first position, the partition is located at an upper position within the chamber, and comprises one or more screen sections having a plurality of screen openings thereon; and one or more non-opening sections being attached to an interior longitudinal wall of the chamber adjacent to the chamber opening, each non-opening section and the interior longitudinal wall of the chamber forming a trough for temporarily storing the litter material.

According to another aspect of the present disclosure, the chamber is rotated from the first position to a second position such that the litter material passes through the screen sections and enters the trough, and the animal waste is kept out of the trough by the partition and dropped to the receptacle through the chamber opening by the gravitational force; and the chamber is rotated from the second position to a third position to bring the litter material out of the trough.

According to another aspect of the present disclosure, the chamber is a semi-open barrel-shaped chamber having the chamber opening on a longitudinal wall of the chamber.

According to another aspect of the present disclosure, each screen opening is sized to permit the litter material to pass through, and to prevent the animal waste with a substantially larger size from passing through.

According to yet another aspect of the present disclosure, there is provided means for rotating the chamber and altering the orientation of the rotation, comprising a motor operatively associated with the chamber and the device base, and a microprocessor controller in communication with the motor. The chamber is encircled by a gear track driven by the motor, and the gear track lies in a vertical plane that is perpendicular to the chamber opening such that the axis of rotation is a horizontal line through the chamber longitudinally.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF THE DRAWINGS

The appended drawings, where like reference numerals refer to identical or functionally similar elements, contain figures of certain embodiments to further illustrate and clarify various aspects, advantages and features of the litter collection device and method disclosed herein. It will be appreciated that these drawings depict only certain embodiments of the invention and are not intended to limit its scope. The litter collection device and the method disclosed herein will be described and explained with additional specificity and detail through the use of the accompanying drawings in which:

FIG. 1 depicts a front view of a litter collection device according to certain embodiments of the present disclosure.

FIG. 2 depicts a side view of the litter collection device of FIG. 1.

FIG. 3 depicts an exploded perspective view of the litter collection device of FIG. 1.

FIG. 4 depicts another exploded perspective view of the litter collection device of FIG. 1.

FIG. 5 depicts an interior view of the litter collection device of FIG. 1 without the upper base and top cover.

FIG. 6 depicts an exploded view of the chamber of FIG. 1.

FIG. 7 depicts an interior view of the litter collection device of FIG. 1 showing the structure of the partition.

FIG. 8 depicts an interior view of the chamber showing the screening of the animal waste from the litter material.

FIG. 9 depicts a perspective view of the receptacle of FIG. 1.

FIG. 10 depicts a side view of the receptacle of FIG. 1.

FIG. 11 depicts an exploded perspective view of the receptacle of FIG. 1.

FIG. 12 depicts a bottom view of the litter collection device of FIG. 1.

FIGS. 13A-13D depict a clockwise rotation of the chamber during the first stage of cleaning cycle for separating and dumping the animal waste.

FIGS. 14A-14E depict a counterclockwise rotation of the chamber during the second stage of cleaning cycle for reintroducing the litter material to the chamber.

FIGS. 15A-15B depict a clockwise rotation of the chamber during the third stage of cleaning cycle for returning to the stand-by position.

FIG. 16 depicts a microprocessor controller for controlling the litter collection device of the present disclosure.

FIG. 17 depicts a flowchart showing the initialization of the litter collection device of FIG. 1.

FIG. 18 depicts a flowchart showing the litter emptying cycle of the litter collection device of FIG. 1.

FIG. 19 depicts a flowchart showing the litter cleaning cycle of the litter collection device of FIG. 1 after being used by a cat.

FIG. 20 depicts a front view of a manually controlled litter collection device according to certain embodiments of the present disclosure.

FIG. 21 depicts an exploded perspective view of the manually controlled litter collection device of FIG. 20.

FIG. 22 depicts a plastic film for attaching to the interior longitudinal wall of the chamber.

FIG. 23 depicts an exploded view of the chamber with a plastic film attached to the interior longitudinal wall of the chamber of FIG. 1.

FIG. 24 depicts a perspective view of the litter collection device of FIG. 1 with a plastic film attached to the interior longitudinal wall of the chamber.

FIG. 25 depicts a perspective view of the receptacle of FIG. 1 when the shutter door is fully closed.

FIG. 26 depicts an exploded view of the receptacle of FIG. 25.

FIG. 27 depicts a perspective view of the receptacle of FIG. 1 when the shutter door is at movement.

FIG. 28 depicts an exploded view of the receptacle of FIG. 27.

FIG. 29 depicts a perspective view of the receptacle of FIG. 1 when the shutter door is fully opened.

FIG. 30 depicts an exploded view of the receptacle of FIG. 29.

### DETAILED DESCRIPTION

The present disclosure relates to a litter collection device for sifting animal waste. More specifically, the present disclosure provides an improved litter collection device that automatically removes animal waste from litter material and dumps the animal waste to a separated container. The litter collection device of the present disclosure is applicable but not limited to animal waste handling. It should be appreciated that a vast number of variations exist. The dimensions provided in the following description are not intended to be limited to those described herein. Without loss of generality, variations in dimensions are also applicable to the present disclosure.

The following terms are used herein in the specification and appended claims. The term “litter material” as used herein is any granular or particulate material that serves as a waste holding media into which the animal may deposit bodily wastes, such as: sand, dried clay, or cat litter. The term “unsoiled litter material” as used herein refers to the litter material that is substantially uncontaminated. The term “animal waste” as used herein means both animal excrement, clumps of litter, and soiled litter material which is the litter material after in contact with animal excrement or urine.

The term “dirty” when used to describe air refers to the air that contains undesirable odors associated with animal waste. The term “clean” when used to describe air refers to the air that is generally odor-free after passing through an odor absorbing filter.

When introducing elements of the present disclosure or the preferred embodiments thereof, the articles “a”, “an” and “the” are not intended to denote a limitation of quantity, but rather to denote the presence of at least one of the items being referred to, unless otherwise indicated or clearly contradicted by context. Further, the terms “comprises”, “comprising”, “including” and “having” are intended to be inclusive and mean that there may be additional elements other than the listed elements.

Terms such as “upper”, “lower”, “inner”, “outer”, “front”, “rear”, and variations thereof herein are used for ease of description to explain the positioning of one element relative to a second element, and are not intended to be limiting to a specific orientation or position.

Terms such as “first”, “second”, and variations thereof herein are used to describe various elements, regions, sections, etc. and are not intended to be limiting.

Terms such as “connected”, “in communication with”, “mounted”, and variations thereof herein are used broadly and encompass direct and indirect connections, communication and mountings; and are not restricted to electrical, physical or mechanical attachments, connections, or mountings.

Furthermore, and as described in subsequent paragraphs, the specific mechanical configurations illustrated in the drawings are intended to exemplify embodiments of the present disclosure and that other alternative mechanical configurations are possible.

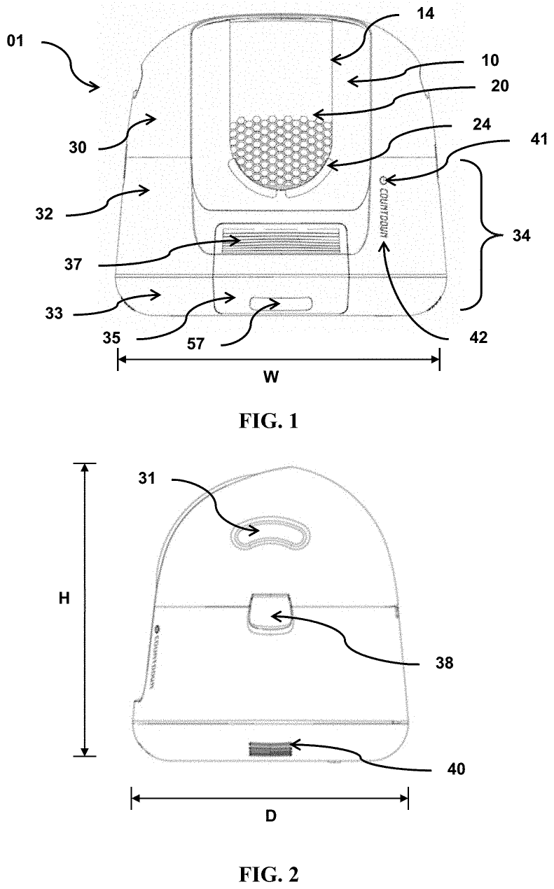

FIG. 1 is a front view of a litter collection device 01 according to the present disclosure, and FIG. 2 is a side view of FIG. 1. The litter collection device 01 can be used for separating litter material 50 of substantially smaller size from animal waste 51 of substantially larger size automatically, and dumping the animal waste 51 into a receptacle 35 for disposal. The litter collection device 01 may be used by any domesticated animals, such as a cat, dog, ferret, squirrel, rabbit, or other pet animals. Preferably, the litter collection device 01 comprises a top cover 30, a device base 34 and a chamber 10. The device base 34 and the top cover 30 are connected to form an outer shell for the litter collection device 01, which collectively provide a cavity for housing the chamber 10. The litter collection device 01 is sized to fit a domesticated animal into the chamber to deposit animal waste 51. In certain embodiments, the litter collection device 01 has a width of 648.6 mm (W), a depth of 529.7 mm (D), and a height of 594.4 mm (H).

The device base 34, with a shape similar to an elliptic cylinder, can be disassembled into an upper base 32 and a lower base 33. The device base 34, which supports the chamber 10 on a surface such as a table, floor, slightly inclined plane or rough surface, may be of any size or shape without departing from the spirit of this disclosure. The upper base 32 is secured on the lower base 33 by a plurality of connecting columns 46. The lower base 33 may comprise a plurality of anti-slippery patterns 40 for increasing the friction between the litter collection device 01 and the surface.

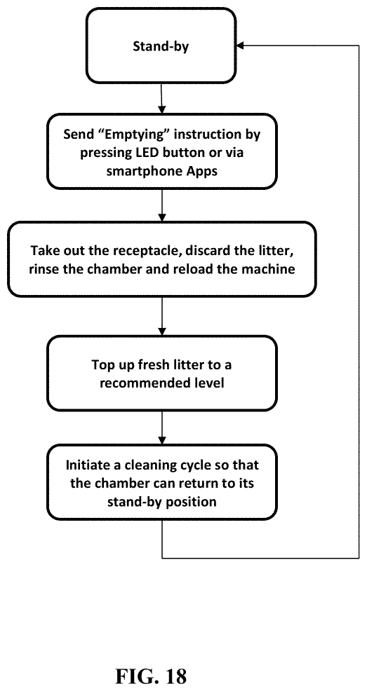

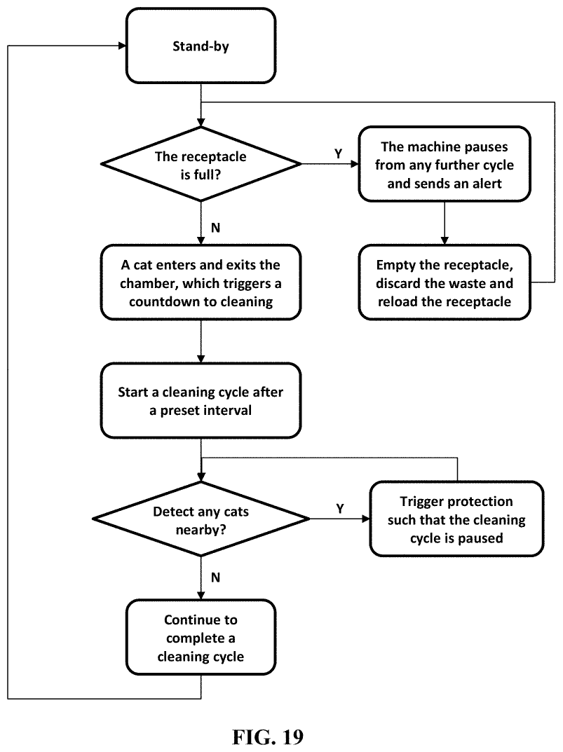

The device base 34 also comprises a receptacle 35 such that the animal waste 51 can be dropped thereto when the chamber 10 is rotated to a position for dumping the animal waste 51. The receptacle 35 includes a plurality of shallow carvings 37 to form an anti-slippery surface texture that may be used by the animal as the step to enter or exit the chamber 10 through the chamber opening 14. The plurality of shallow carvings 37 can be made of rubber, plastic, polymer, natural material, synthetic material, or a combination thereof. The plurality of shallow carvings 37 is inclined by an angle in the range of 30 to 60 degrees from the vertical plane, and has a rough surface texture so that it is not too slippery for the animal. In certain embodiments, the shallow carvings 37 can be a separated platform with an anti-slippery surface for the animal to step in. A doorstep 24 can be attached to the chamber opening 14 as an entry passage for assisting smaller animal to step into the chamber 10. The doorstep 24 also comprises a plurality of holes arranged in rows and columns, in which the animals can clean the litter material 50 or other remnants stuck on their paws. The doorstep 24 can be remained attaching to the chamber opening 14 during the litter cleaning cycle (FIG. 19), but should be disassembled during the litter emptying cycle (FIG. 18) such that the litter material 50 would not be hindered or prevented from falling into the receptacle 35. The receptacle 35 can be opened by a receptacle handle 57.

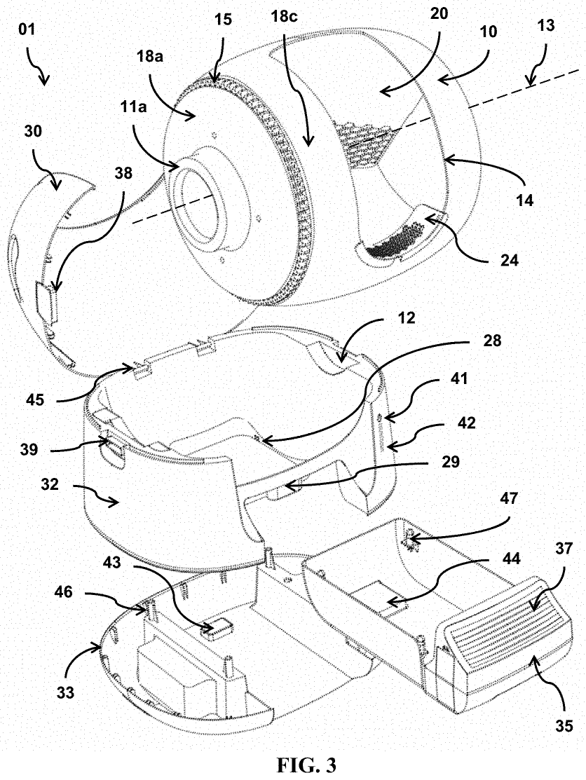

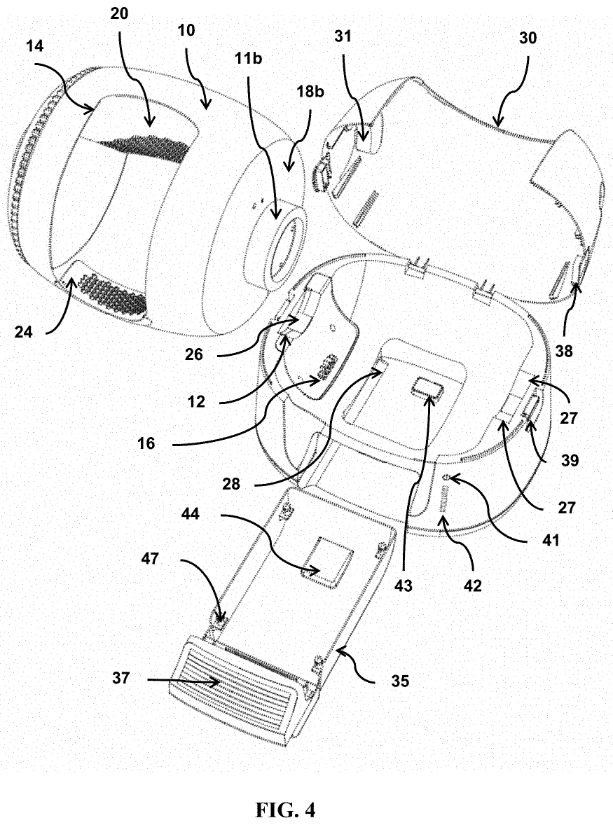

The top cover 30 is a protective case at the upper portion of the litter collection device 01 covering the chamber 10, which comprises one or more device handles 31 and one or more hinges 45. The top cover 30 can be made from plastic, wood, metal, or other transparent material such as glass or acrylic glass. The top cover 30 and the device base 34 are connected via one or more hinges 45 on the rear side of the top cover 30. The hinges 45 are pivoting the top cover 30 with respect to the device base 34, such that the top cover is openable against the chamber 10 for preventing the animal from getting inside the chamber 10 during rotation. As shown in FIGS. 3 and 4, the top cover 30 further comprises one or more locking clamps 38 and the device base 34 further comprises one or more locking protrusions 39, for securing and fastening the top cover 30 onto the device base 34. In certain embodiments, the litter collection device 01 may not have a top cover 30 without departing from the spirit of this disclosure and so the chamber 10 is at the top of the litter collection device 01.

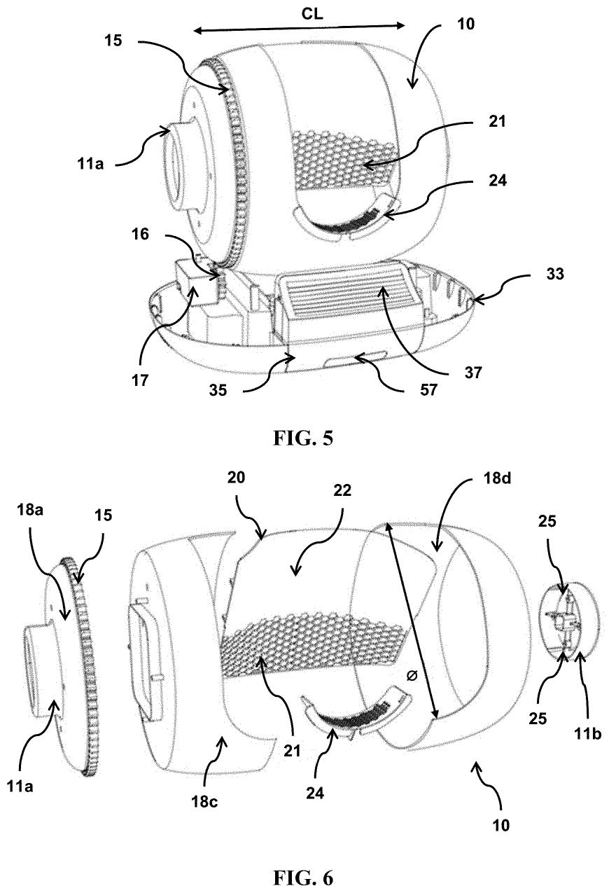

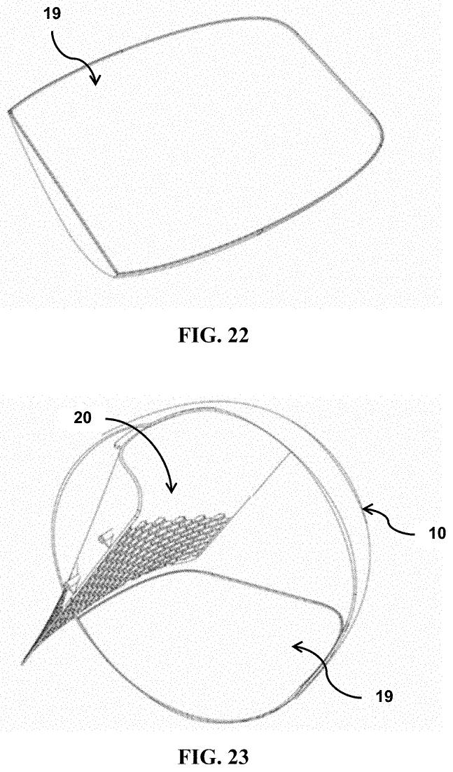

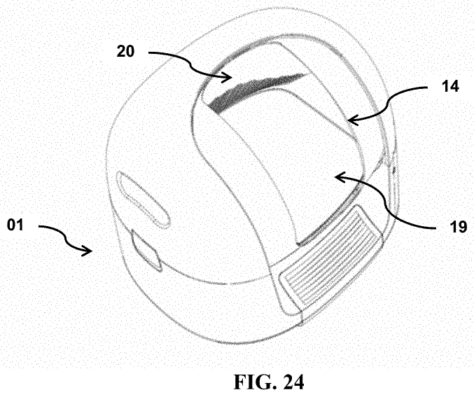

Referring to FIGS. 3 to 6, a chamber 10 is located on the device base 34 and housed in a cavity enclosed within the device base 34 and the top cover 30. The chamber 10 is a semi-open circular chamber in the shape of a barrel with a longitudinal length (CL) in the range of 400 mm to 500 mm. The cross-sectional diameter (∅) of the chamber 10 at the middle of the longitudinal side of the chamber 10 is around 460 mm. The chamber 10 may be shaped like a globe or a sphere. Preferably, the chamber 10 is large enough so that most pet animals can fit within the chamber 10. In particular, animals with a taller size may poke their head out vertically from the chamber opening 14 without being obstructed. Litter material 50 is placed at the inner bottom part of the chamber 10, and preferably the chamber 10 is partially filled with the litter material 50 to a level not higher than the chamber opening 14. The litter material 50 can give the animal a feeling similar to the outdoor environment when depositing animal waste 51 thereon. As shown in FIG. 22-24, plastic films 19 or other disposable layers are attached to the interior longitudinal wall 18d so that the chamber 10 is prevented from being polluted or stuck by the litter material 50 or the animal waste 51. The chamber 10 comprises a partition 20, a gear track 15, a chamber opening 14, a left wheel cap 11a and a right wheel cap 11b. Both the left and right longitudinal end 18a, 18b of the chamber 10 are closed, while the left longitudinal end 18a of the chamber 10 (to the left in FIG. 5) is encircled by a gear track 15. The left wheel cap 11a is assembled on the left longitudinal end 18a, and the right wheel cap 11b is assembled on the right longitudinal end 18b. When the chamber 10 is rested on the device base 34, the two wheel caps 11a, 11b are supported by the two semi-circular notches 12 of the device base 34.

The chamber 10 is rotatable about an axis of rotation 13 which is a horizontal line through the chamber 10 from the center of the left wheel cap 11a to the center of the right wheel cap 11b. The axis of rotation 13 can be defined as a virtual line that is perpendicular to both the vertical plane and the direction of the movement of an animal when entering and exiting the chamber 10 through the chamber opening 14. The rotation is bi-directional and can be operated manually or automatically. As shown in FIG. 5, the rotation of the chamber 10 and the corresponding alternation of orientation are driven by a motor 17 automatically. The gear track 15 on the chamber 10 cooperates with a motor gear 16 that is secured to the output shaft of the motor 17. The motor gear 16 lies in the same vertical plane as the gear track 15 at the left side of the device base 34. A microprocessor controller 60 controls and is in communication with the motor 17 to determine the angle of rotation and the corresponding orientation of the chamber 10. It is apparent that the gear track 15 may be placed on the right longitudinal end 18b of the chamber 10 if the motor 17 and the motor gear 16 are located at the right side of the device base 34 without departing from the spirit of this disclosure. In certain embodiments, the motor gear 16 has a module size (m) of 5 with 12 teeth (z), and the gear track 15 has a module size (m) of 5 with 78 teeth (z). The motor 17 drives the motor gear 16 with a turning speed of, and one example, 0.065 rad/sec, which can complete turning a full cleaning cycle in approximately 97 seconds. The gear ratio of the gear track 15 and the motor gear 16 is high, preferably in a range between about 2 to 20, which amplifies the output torque. The frictional force incurred between the wheel caps 11a, 11b and the semi-circular notches 12 is minimized by the circular contact thereof. The chamber 10 can be rotated to a plurality of positions, including a first position as the stand-by position allowing an animal to enter and exit the chamber 10 through the chamber opening 14, a second position as the waste dumping position for removing the animal waste 51 from the chamber 10, and a third position as the litter reintroduction position for reintroducing the litter material 50 into the chamber 10.

On the front of the device base 34, there is an LED button 41 and a display panel 42. The LED button 41 is a switch button for controlling the litter collection device 01 with various functions, including pausing, triggering a cleaning cycle, triggering an empty cycle, connecting to a portable device via WIFI, or switching the power ON/OFF. The display panel 42 shows the status of the litter collection device 01, including countdown, cleaning, emptying, full, error, and pairing (WIFI), etc. The LED button 41 and the display panel 42 of the present disclosure do not necessarily implemented using light emitting diodes, they could also be realized with other alternative lighting or display devices.

Attached on the curved surface of each of the semi-circular notches 12, one or more Hall Effect sensors 27 are provided. Inside each of the wheel caps 11a, 11b, one or more permanent magnet 25 is also provided. The Hall Effect sensor 27 and the permanent magnets 25 combine to form a position sensor unit for detecting the position of the chamber 10 with respect to the device base 34, and supplying one or more position signals to the microprocessor controller 60. The Hall Effect sensor 27 detects the positions of the permanent magnets 25 for determining the degree of rotation of the chamber 10, such that the orientation of the chamber 10 can be accurately determined and controlled.

Attached on the bottom surface of each of the semi-circular notches 12, a chamber weight sensor 26 is provided. The chamber weight sensors 26 are used to detect any change of weight of the entire chamber 10, either caused by an entry or an exit of the animal or a change of the litter material 50 and/or animal waste 51. One or more chamber weight signals are supplied to the microprocessor controller 60 for determining whether an animal is present within the chamber 10.

As shown in FIGS. 3-4, a receptacle weight sensor 43 is positioned at the bottom of the device base 34. When the receptacle 35 is properly installed to the device base 34, the receptacle weight sensor 43 is placed under the sensor slot 44, which can be used to detect any change of weight of the receptacle 35 and the content therein. The receptacle weight sensor 43 can be a strain gauge, load cell, a force-sensing resistor or a combination thereof. A receptacle weight signal is supplied to the microprocessor controller 60 for determining whether the receptacle area 36 is full of animal waste 51 or not.

Also shown in FIGS. 3-4, one or more waste level gauges 28 are positioned inside the device base 34 adjacent to the receptacle 35. The waste level gauges 28 are used to detect the level of waste accumulated in the receptacle 35. The waste level gauge 28 can be an infrared sensor, a laser sensor, a camera or a combination thereof. One or more waste level signals are supplied to the microprocessor controller 60 for determining whether the receptacle area 36 is full of animal waste 51 or not.

In order to drive the motor 17, sensors, LEDs, microprocessor controller 60 and other electronic parts, electrical power is supplied to the device base 34. The electrical power can be supplied to the litter collection device 01 from a battery, a power outlet, or alternatively through a voltage regulator. Interconnecting wiring and cables, power supply housing and other electronic parts are used in the device base 34. For convenience and simplicity, the electrical power and the respective electronic parts have not been shown in the figures.

The chamber opening 14 is positioned on a longitudinal wall 18c at the middle of the chamber 10, which is a rectangular opening preferably having a height of around 515.4 mm and a width of 200.6 mm along the circular barrel-shaped surface. In certain embodiments, the chamber opening 14 can be made larger in height and the top cover 30 can be removed, such that the chamber 10 can have no ceiling at the first position. The “no ceiling” arrangement can provide more space for animals of larger size to enter and use the litter collection device 01. In particular, animals with taller size may poke their head out vertically from the chamber opening 14 without being obstructed.

Advantageously, the chamber opening 14 is operable as an ingress and an egress for the animal to deposit the animal waste 51 when the chamber 10 is in the first position, and the chamber opening 14 is operable as a waste opening for dumping the animal waste 51 to the receptacle 35 when the chamber 10 is rotated by a predetermined angle to the second position such that the animal waste 51 is dropped down into the receptacle 35 in the device base 34 by gravitational force.

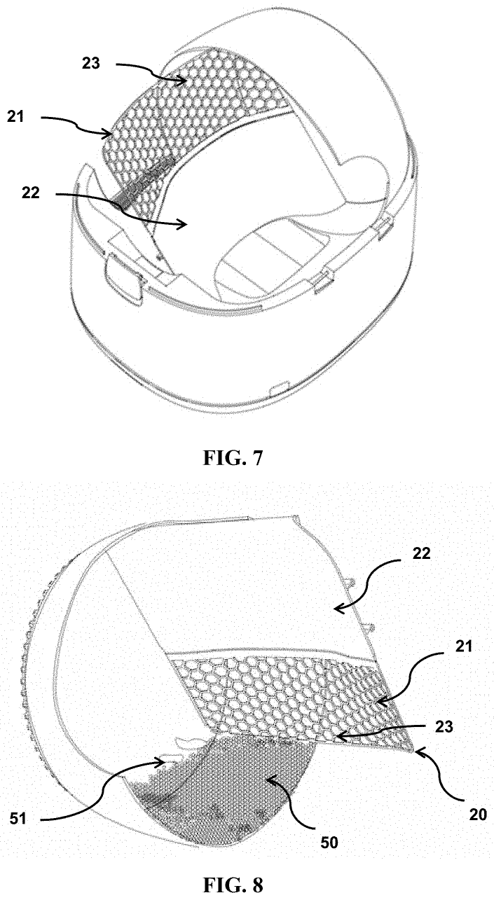

As seen in FIGS. 6 and 7, the partition 20 comprises one or more screen sections 21 each having a plurality of screen openings 23 thereon and one or more non-opening sections 22 without any screen openings. The partition 20 is generally flat and may be made of plastic, metal or any other suitable material. The non-opening section 22 of the partition 20 is glued or otherwise attached to an interior longitudinal wall 18d of the chamber 10 adjacent to the chamber opening 14. The partition 20 is not moveable on its own, but it rotates together with and in the same manner as the chamber 10. The non-opening section 22 and the interior longitudinal wall 18d of the chamber 10 collectively form a trough 52 such that the litter material 50 passes through the screen section 21 of the partition 20, enters the trough 52 and be retained inside the trough 52. The animal waste 51 of substantially larger size cannot pass through the screen section 21 of the partition 20. Therefore, the animal waste 51 is retained by the screen section 21 and kept out of the trough 52.

As shown in FIG. 8, each screen opening 23 on the screen section 21 is sized to permit the litter material 50 to pass through, and to prevent the animal waste 51 with a substantially larger size from passing through. In certain embodiments, the screen opening 23 has a hexagonal shape with a diagonal between about 10 mm and about 30 mm, or a rounded rectangle shape with a size of about 10 mm×20 mm. The litter material 50 passing through the screen opening 23 is unsoiled litter material which is substantially uncontaminated by the animal waste 51. The litter material 50 is retained within the trough 52 for future use when dumping the animal waste 51, and can be used again when the chamber 10 is rotated back to the stand-by position.

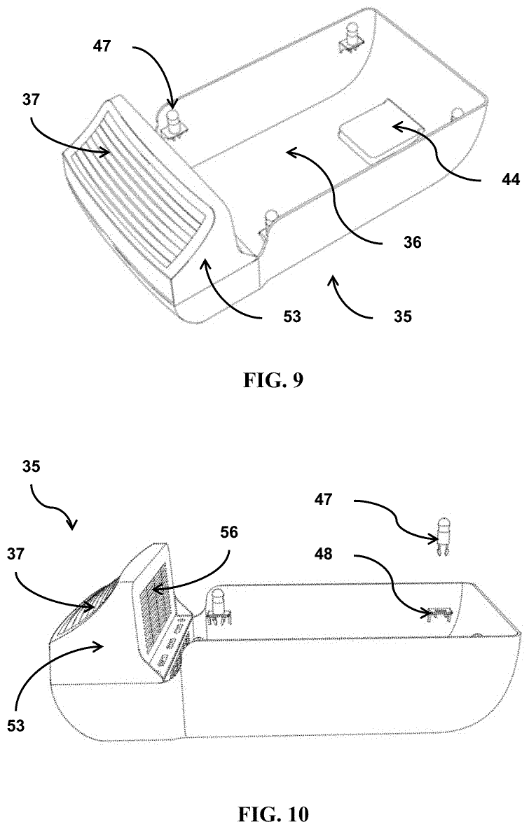

FIGS. 9 and 10 show various views of the receptacle 35 according to the present disclosure. The receptacle 35 comprises a receptacle area 36, a plurality of connection bolts 47 and a deodorizing unit 53. The receptacle 35 is adapted to receive one or more storage bags or plastic bags (not shown in the figures) and further comprises means for facilitating installation and removal of the storage bags or plastic bags. The installation and removal of the storage bags or plastic bags can be achieved with various mounting devices, such as using one or more connection bolts 47 and one or more connection slots 48. Each of the connection bolts 47 is attached to the cooperating connection slot 48 inside the receptacle area 36, such that the storage bags or plastic bags to be mounted within the receptacle 35 for collecting the animal waste 51 and can be conveniently removed from the receptacle 35.

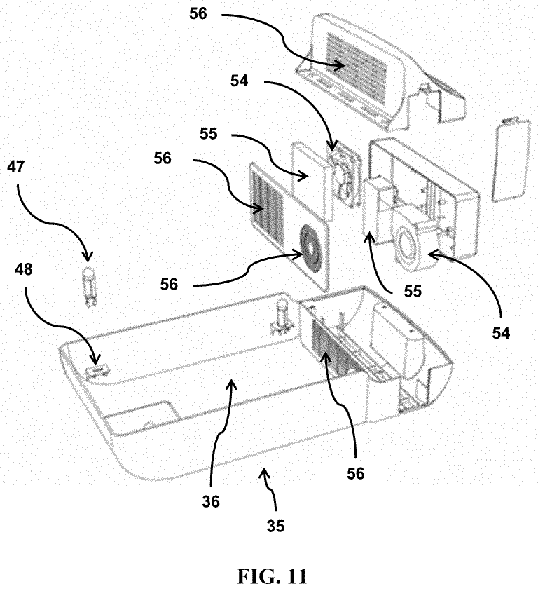

The internal structure of the deodorizing unit 53 is shown in the exploded view of the receptacle 35 in FIG. 11. The deodorizing unit 53 is a compact air treatment device that is installed within the receptacle 35 for creating a circulation of air within the device base 34 and sanitizing the air inside the receptacle 35. The deodorizing unit 53 comprises one or more fans 54, one or more filters 55 and one or more vents 56. The filter 55 is an absorbent made of an odor absorbing material, such as an activated charcoal, silica gel, zeolite, or a combination thereof. The air circulation within the receptacle 35 is performed from one vent 56 to another vent 56. The filter 55 is positioned in front of the fan 54 along the air path, such that the dirty air drawn into the vent 56 by the fan 54 is filtered to remove the undesirable odor, and expelled out to the receptacle 35 through another vent 56. The air expelled from the deodorizing unit 53 is generally clean and odor-free. If the filters 55 are replaced with other anti-bacteria filters, the deodorizing unit 53 can also minimize the bacteria growth within the litter collection device 01.

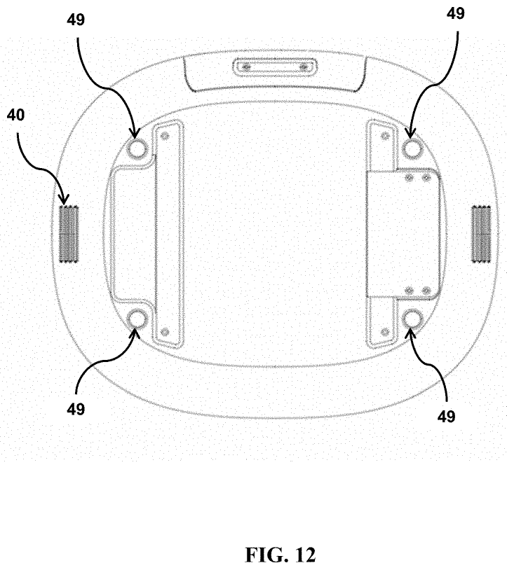

FIG. 12 shows a bottom view of the litter collection device 01. At the bottom there is a plurality of device weight sensors 49 in contact with the surface. The device weight sensor 49 can be a strain gauge, load cell, a force-sensing resistor or a combination thereof. The device weight sensors 49 are used to detect any change of weight of the entire litter collection device 01, either caused by an entry or an exit of the animal, a change of the litter material 50, or a disposal of waste material 51 to the receptacle 35. One or more device weight signals are supplied to the microprocessor controller 60.

The litter collection device 01 further comprises one or more presence sensors 29 for detecting a presence or an absence of the animal within a predetermined distance from the chamber 10. The presence sensor 29 can be a microwave radar, an ultrasonic sensor, an infrared sensor, a camera, a thermal imaging sensor, a millimeter-wave radar, a laser sensor or a combination thereof. One or more presence signals are supplied to the microprocessor controller 60.

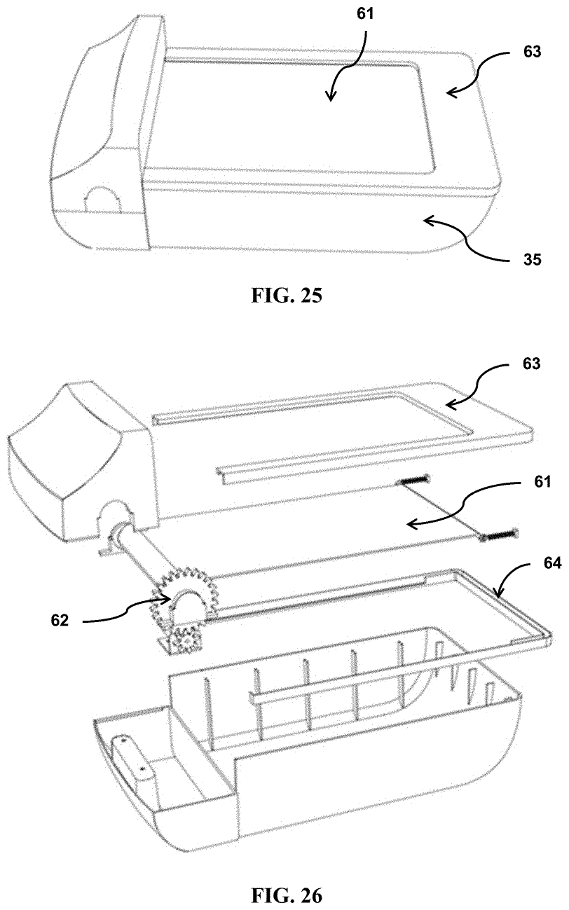

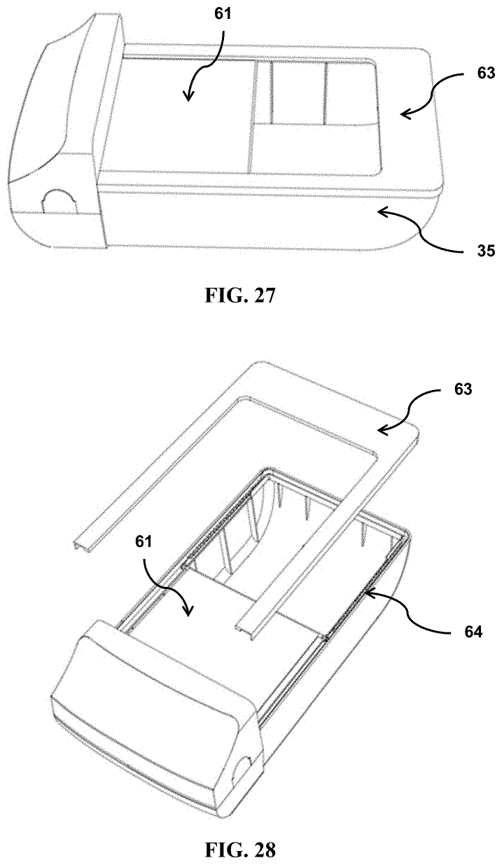

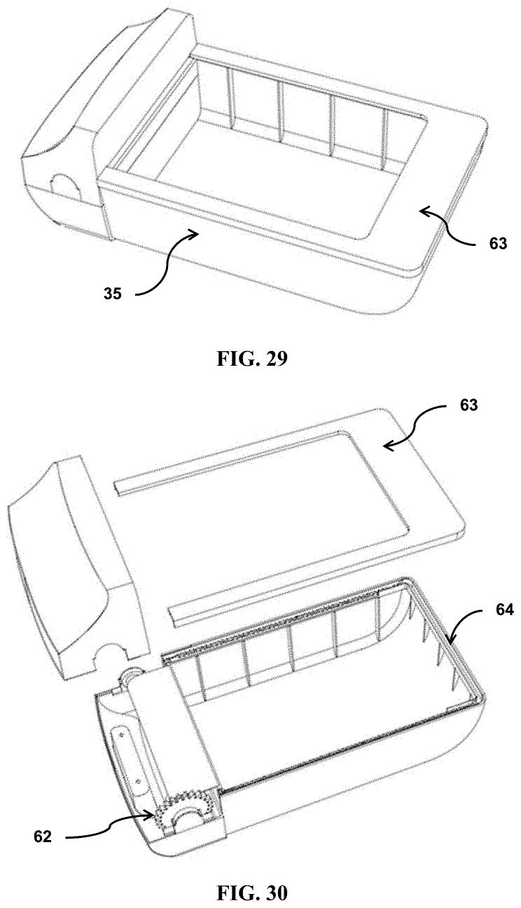

FIG. 25 is a simplified view showing the receptacle 35 with a shutter door 61 fully closed. FIG. 27 shows the receptacle 35 when the shutter door 61 is at movement and FIG. 29 shows the receptacle 35 when the shutter door 61 is fully opened. The respective exploded views are shown in FIG. 26, FIG. 28 and FIG. 30. The shutter door 61 is an add-on component that can be used to contain or control the unpleasant odors from the animal waste 51 in the receptacle 35. A shutter track 64 is a track allowing the shutter door 61 to move along, and placed atop the receptacle area 36. The shutter door 61 is extended from one end of the receptacle area 36 to an opposite end of the receptacle area 36. The movement of the shutter door 61 is driven by a plurality of shutter gears 62 and a shutter motor (not shown in the figures), controllable by the microprocessor controller 60. A shutter cover 63, preferably with a shape of the letter “U”, is positioned above the shutter door 61. The shutter cover 63 and the shutter door 61 at closed position collectively form an airtight partition for preventing the unpleasant odor of the animal waste 51 from entering the chamber or any other parts of the litter collection device 01.

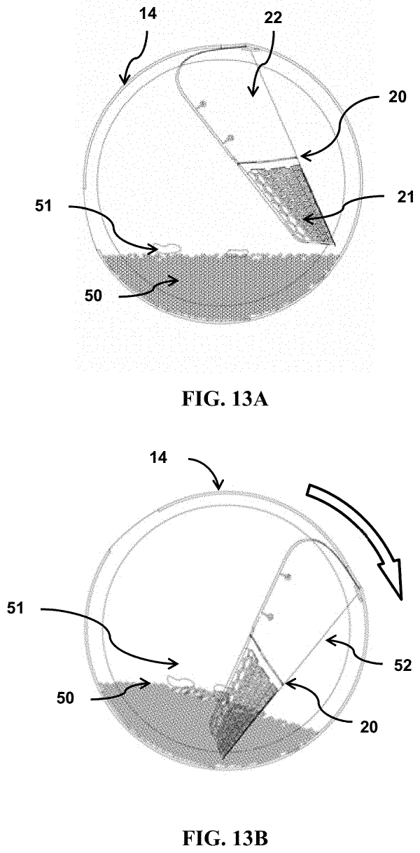

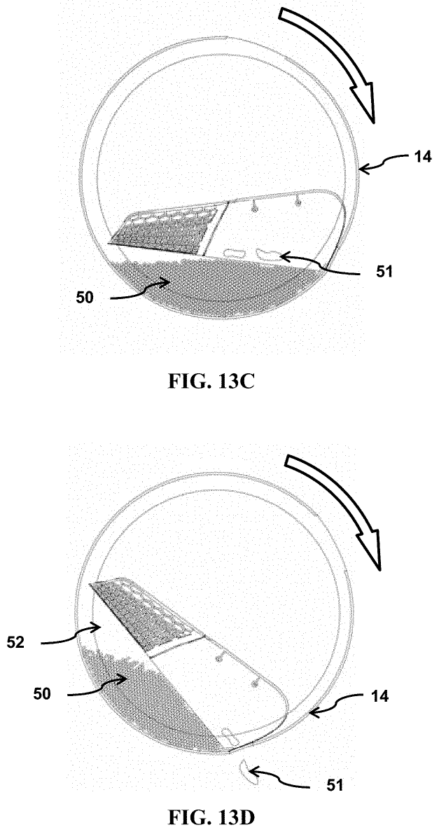

During the litter cleaning cycle, the litter collection device 01 can be seen to operate as follows and as is shown in FIGS. 13A-13D, 14A-14E and 15A-15B. The stand-by position of the chamber 10 is shown in FIG. 5 and the cross-sectional view thereof is depicted in FIG. 13A. A desired quantity of litter material 50 can be placed into the chamber 10. The animal enters the chamber 10 through the chamber opening 14 and deposits the animal waste 51 into the litter material 50 in the stand-by position as shown in FIG. 13A. At a subsequent time, when the device 01 begins a litter cleaning cycle, the chamber 10 is rotated by a first angle from the stand-by position as shown in FIG. 13A to a waste dumping position (second position) as shown in FIG. 13D in a clockwise direction (as viewed in FIGS. 13B-13D). The first angle could be in the range of 120° to 180° clockwise and is preferably 150° clockwise. During the rotation, the litter material 50 slides along the internal surface of the chamber 10 by the gravitational force, passes through the screen section 21 and enters the trough 52. Concurrently, the animal waste 51 with a substantially larger size is too large to sift so that the animal waste 51 will continue to slide through the screen, and keep out of the trough 52 by the partition 20. When the chamber opening 14 is rotated to a position above the receptacle 35, the animal waste 51 will then drop out through the chamber opening 14 to the receptacle 35 by the gravitational force. Thereby, the animal waste 51 is separated from the litter material 50 by the partition 20. As can be seen in FIGS. 13C and 13D, the litter material 50 is trapped within the trough 52 and can be reused.

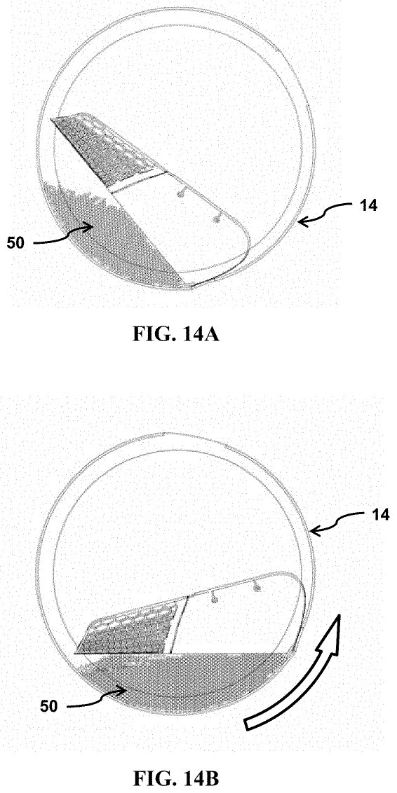

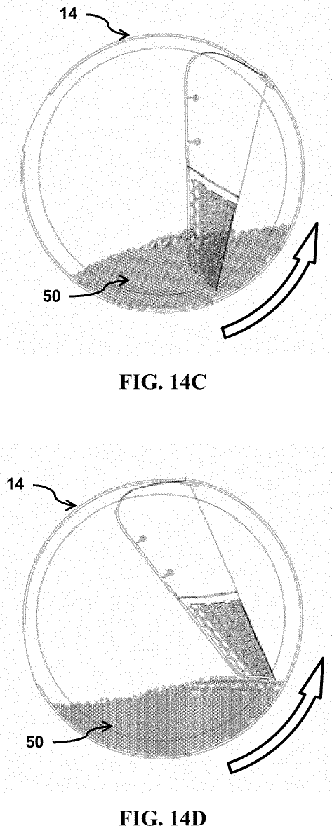

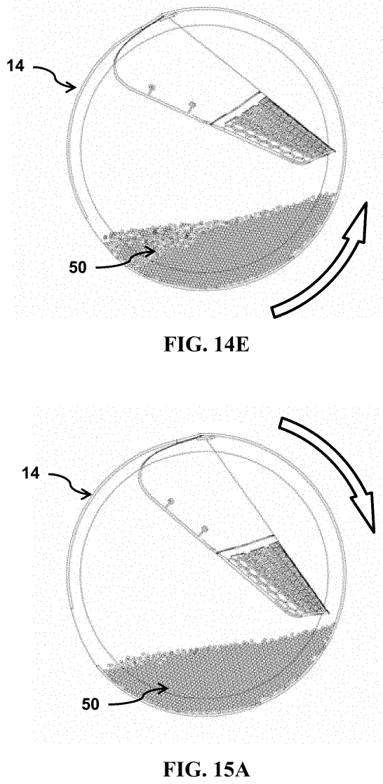

After dumping the animal waste 51 into the receptacle 35, the chamber 10 is rotated in an opposite direction by a second angle (counterclockwise as viewed in FIGS. 14A-14E) to a third position. The second angle could be in the range of 145° to 205° counterclockwise and is preferably 175° counterclockwise. By doing so, the litter material 50 is reintroduced such that it passes through the screen section 21 for the second time during the counterclockwise rotation and leaves the trough 52. Thus, the trough 52 is emptied when the chamber 10 is rotated to the third position as shown in FIG. 14E. It can be appreciated that the litter material 50 has not been dropped from a significant height to the bottom of the chamber 10 but instead has smoothly slid along the inner surface of the chamber 10. Alternatively, if the chamber 10 rotates clockwise to the third position, the litter material 50 would first be trapped temporarily in the trough 52 as it cannot pass through the wall of the non-opening section 22, then be dropped from a significant height to the bottom of the rotatable chamber when the partition 20 is rotated to the top before the chamber 10 reaches the third position as shown in FIG. 14E.

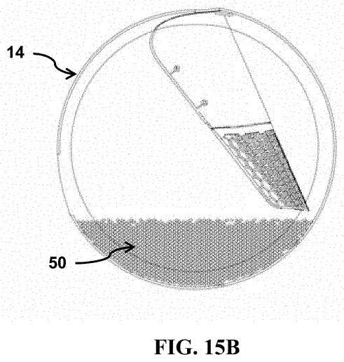

After reintroducing the litter material 50, the chamber 10 is rotated in the clockwise direction by a third angle (as viewed in FIGS. 15A-15B) for restoring the stand-by position (FIG. 15B). The third angle is preferably 25° clockwise or an angular difference between the first angle and the second angle. This would enable the animal to enter the chamber 10 again at the first position via the chamber opening 14 to deposit animal waste 51 again.

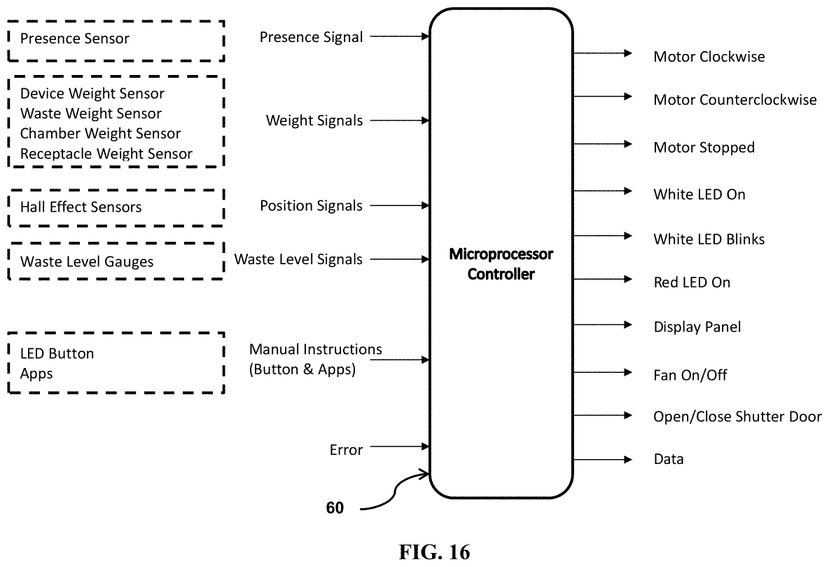

As shown in FIG. 16, a microprocessor controller 60 for controlling the litter collection device 01 is depicted. The microprocessor controller 60 may be implemented using general purpose or specialized computing devices, encompassed within a microcontroller unit (MCU), a custom integrated circuit, a digital signal processors (DSP), a field-programmable gate array (FPGA), an application specific integrated circuits (ASIC), a central processing unit (CPU), a graphics processing unit (GPU), a computer device to perform a method, a programmable I/O device, other semiconductor devices, or any suitable combination of the foregoing for executing a method for controlling the litter collection device 01 in accordance with the methods described herein.

The microprocessor controller 60 receives a plurality of input signals from a plurality of sensors. The plurality of input signals comprises presence signal, weight signals, position signals, and waste level signals. The presence signal is supplied by the presence sensor 29. The weight signals, including one or more chamber weight signals, a receptacle weight signal, and one or more device weight signals, are supplied by the chamber weight sensors 26, the receptacle weight sensor 43, and the device weight sensors 49 respectively. The position signals are supplied by the Hall Effect sensors 27. The waste level signals are supplied by the waste level gauges 28.

The microprocessor controller 60 also receives manual instructions from the LED button 41 and/or signals from App. The LED button 41 supports control of the litter collection device by a single press, a press and held, and/or a double-press. When the litter collection device 01 is controlled by an App, data transmissions can be established between a smartphone and the litter collection device 01, using wireless communication methods such as Wi-Fi, Bluetooth, Wireless Body Area Network (WBAN), or other wired connections including inter-integrated circuit (I²C), and serial (COM) communication. When there is any malfunction detected, the microprocessor controller 60 can also receive an error signal, which can immediately put the operation in pause until an interruption by the user.

The microprocessor controller 60 responds to the foregoing input signals to provide a plurality of output signals, including a motor control signal for rotating the motor 17 clockwise, or counterclockwise, a motor stop signal, a white LED enable/blinking signal for controlling the white LED in the LED button 41, a red LED enable signal for turning the LED button 41 on with a red color, a plurality of control signals for driving the display panel 42, an enable signal for turning the fan 54 on/off, an enable signal for closing/opening the shutter door 61, and other data signals for data recording.

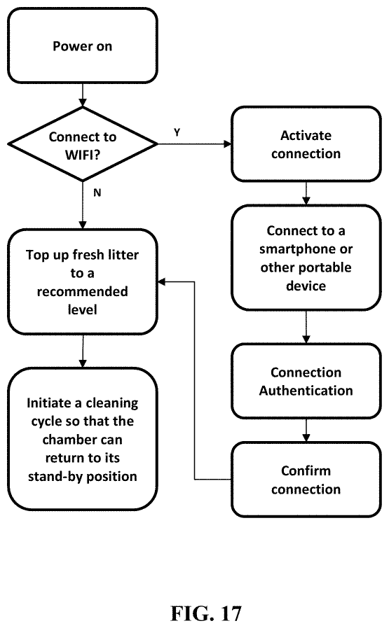

FIG. 17 is a flowchart showing the initialization of the litter collection device 01. Upon powering on the litter collection device 01, the litter collection device 01 can first be connected to a smartphone by a Wi-Fi connection. The user can then top up fresh litter material 50 to the chamber 10 to a recommended level. Preferably the recommended level of litter material 50 is not higher than the chamber opening 14.

FIG. 18 is a flowchart showing a litter emptying cycle of the litter collection device 01 for dumping the litter material 50. When the litter material needs to be changed from time to time, the user may manually trigger an empty instruction to the litter collection device 01 via smartphone apps or by pressing the LED button 41. Under the empty instruction, the chamber 10 is rotated in a counterclockwise manner (opposite direction as the rotation in the litter cleaning cycle) and the litter material 50 will fall into the receptacle 35. The user can remove the litter material 50 by removing the receptacle 35, discarding the content therein, rinsing the chamber 10, and reloading the receptacle 35 back to the litter collection device 01. The litter material 50 can then be refilled to a recommended level, and the user can initiate a new cleaning cycle so that the chamber 10 can be returned to its stand-by position.

FIG. 19 is a flowchart showing the automatic litter cleaning cycle of the litter collection device 01 after being used by a cat. The waste level gauges 28 and the receptacle weight sensor 43 first determine a waste level of the receptacle 35, such that the litter device 01 is paused from any further cycle and provides an alert to the user if the receptacle 35 is full. After a cat enters and subsequently exits the chamber 10 through the chamber opening 14 when the chamber 10 is in the stand-by position, a countdown is triggered for initiating a cleaning cycle. The countdown for a preset interval allows sufficient time for the litter material 50 to clump with the urine of the animal. Typically, the preset interval is about 10 minutes. The presence sensor 29 determines whether an animal is within a predetermined distance from the chamber 10. The chamber weight sensor 26 and the device weight sensor 49 determine whether an animal is within the chamber 10. If an animal is detected to be within the chamber 10 or within a predetermined distance from the chamber 10, a protection procedure is triggered such that the litter cleaning cycle is paused until no animal is detected. The chamber 10 is then rotated by a first angle from the stand-by position to the waste dumping position (FIGS. 13A-13D) such that the animal waste 51 is separated from the litter material 50 by the partition 20 and is dropped to the receptacle 35 through the chamber opening 14 by gravitational force. After dumping the animal waste 51, the chamber 10 is rotated in an opposite direction by a second angle (FIGS. 14A-14E) to a third position for reintroducing lifter material, and rotated by a third angle (FIGS. 15A-15B) for restoring the stand-by position.

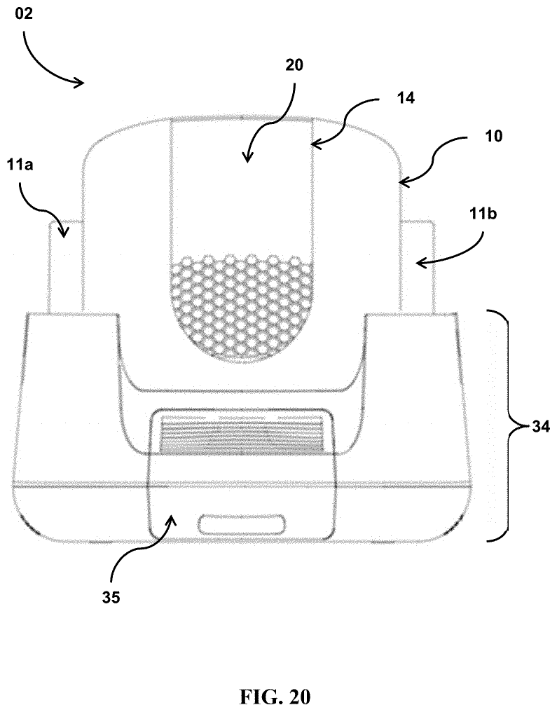

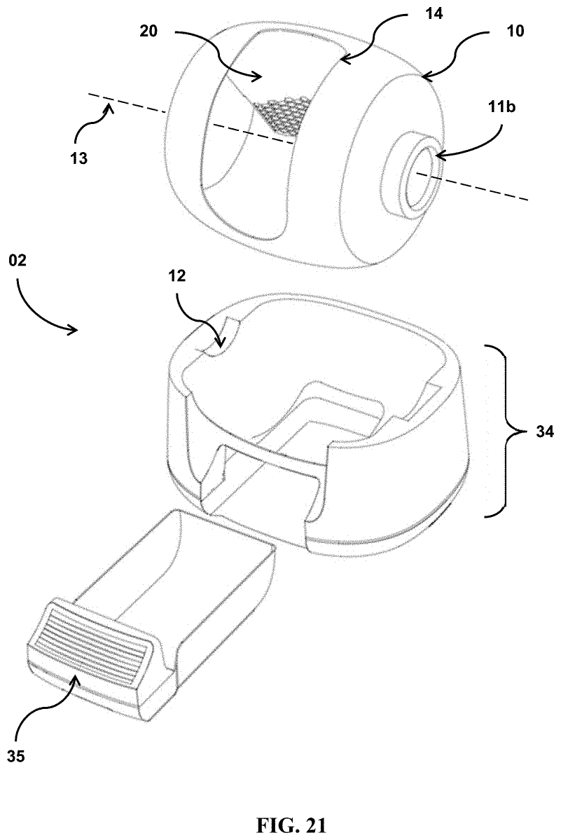

In accordance with an alternative embodiment, the present disclosure also provides a manually controlled litter collection device 02 as depicted in FIGS. 20-21. The manually controlled litter collection device 02 can be used for separating litter material 50 of substantially smaller size from animal waste 51 of substantially larger size by a manual movement of the chamber 10, and dumping the animal waste 51 into a receptacle 35 for disposal. Preferably, the manually controlled litter collection device 02 comprises a device base 34 and a chamber 10. The chamber 10 comprises a partition 20, a chamber opening 14, a left wheel cap 11a and a right wheel cap 11b. The chamber 10 is located on the device base 34 and is rotatable about an axis of rotation 13. When the chamber 10 is rested on the device base 34, the two wheel caps 11a, 11b are supported by the two semi-circular notches 12. The axis of rotation 13 is a horizontal line through the chamber from the center of the left wheel cap 11a to the center of the right wheel cap 11b, which can be defined as a virtual line that is perpendicular to both the vertical plane and the direction of the movement of an animal when entering and exiting the chamber 10 through the chamber opening 14.

The rotation is bi-directional and can be operated by manual turning the chamber 10, such that the chamber 10 can be rotated to a plurality of positions, including a first position as the stand-by position allowing an animal to enter and exit the chamber 10 through the chamber opening 14, a second position as the waste dumping position for removing the animal waste 51 from the chamber 10, and a third position as the litter reintroduction position for reintroducing the litter material 50 into the chamber 10. The chamber opening 14 is operable as an ingress and an egress for the animal to deposit the animal waste 51 when the chamber 10 is in the first position, and the chamber opening 14 is operable as a waste opening for dumping the animal waste 51 to the receptacle 35 when the chamber 10 is rotated by a predetermined angle to the second position such that the animal waste 51 is dropped down into the receptacle 35 in the device base 34 by gravitational force. The structure of the partition 20 is the same as the partition 20 in the litter collection device 01 comprising one or more screen sections 21 each having a plurality of screen openings 23 thereon and one or more non-opening sections 22 without any screen openings. Therefore, the partition 20 operates to screen the animal waste 51 from the litter material 50 by the movement of the chamber 10. After the animal waste 51 is dumped into the receptacle 35, the chamber 10 is rotated by a second angle to the third position for reintroducing the litter material 50, and then by a third angle back to the stand-by position for leveling the litter material 50.

Accordingly, various structures and devices for separating a litter material from an animal waste deposited by an animal, and dumping the animal waste are provided. While exemplary embodiments have been presented in the foregoing detailed description of the invention, it should be appreciated that a vast number of equivalent variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing an exemplary embodiment of the invention. Various changes may be made in the function and arrangement of elements described in an exemplary embodiment without departing from the scope of the invention as set forth in the appended claims and their legal equivalents.

What is claimed is:

1. A device for handling an animal waste deposited by an animal, the device comprising:
a device base comprising a receptacle; and
a chamber located on the device base for receiving the animal waste, the chamber containing a litter material, being rotatable about an axis of rotation and comprising a chamber opening and a partition, wherein:
the chamber opening is operable as an ingress and an egress for the animal to deposit the animal waste when the chamber is in a first position;
the chamber opening is operable as a waste opening for dumping the animal waste to the receptacle;
the partition is located at an upper position within the chamber when the chamber is in the first position, and comprises:
one or more screen sections having a plurality of screen openings thereon; and
one or more non-opening sections being attached to an interior longitudinal wall of the chamber adjacent to the chamber opening, each non-opening section and the interior longitudinal wall of the chamber forming a trough for temporarily storing the litter material;
as the chamber is rotated from the first position to a second position, the litter material passes through the screen sections and enters the trough, and the animal waste is kept out of the trough by the partition and dropped to the receptacle through the chamber opening by the gravitational force; and
the chamber is rotated from the second position to a third position to bring the litter material out of the trough.

2. The device of claim 1, wherein the chamber is a semi-open barrel-shaped chamber having the chamber opening on a longitudinal wall of the chamber.

3. The device of claim 1, wherein each screen opening has a hexagonal shape sized to permit the litter material to pass through, and to prevent the animal waste with a substantially larger size from passing through.

4. The device of claim 1, wherein the receptacle comprises a shutter door and a plurality of shutter gears rotatable for opening or closing the shutter door, such that unpleasant odors from the animal waste can be contained within the receptacle when the shutter door is closed to form an airtight partition.

5. The device of claim 1 further comprising means disposed within the chamber for protecting an interior surface of the chamber from being polluted or stuck by the litter material or the animal waste.

6. The device of claim 1, wherein the receptacle is adapted to receive one or more storage bags and further comprises means for facilitating an installation and a removal of the storage bags.

7. The device of claim 1 further comprising a deodorizing unit for creating a circulation of air within the device base and sanitizing the air inside the receptacle, wherein the deodorizing unit comprises:
one or more fans;
one or more vents; and
one or more filters.

8. The device of claim 1 further comprising means for rotating the chamber and altering the orientation of the rotation.

9. The device of claim 8, wherein the means for rotating the chamber and altering the orientation of the rotation comprises:
a motor operatively associated with the chamber and the device base; and
a microprocessor controller in communication with the motor.

10. The device of claim 9, wherein the chamber is encircled by a gear track driven by the motor, the gear track lying in a vertical plane that is perpendicular to the chamber opening such that the axis of rotation is a horizontal line through the chamber longitudinally.

11. The device of claim 10 further comprising a motor gear, wherein a gear ratio of the gear track and the motor gear is in a range between 2 and 20.

12. The device of claim 9 further comprising a top cover for covering the chamber, wherein the top cover comprises one or more hinges for pivoting the top cover with respect to the device base such that the top cover is openable against the chamber for preventing the animal from getting inside the chamber during rotation.

13. The device of claim 12 further comprising one or more locking clamps and one or more locking protrusions for securing and fastening the top cover onto the device base.

14. The device of claim 9 further comprising a position sensor unit for detecting the position of the chamber relative to the device base and for supplying a position signal to the microprocessor controller.

15. The device of claim 14, wherein the position sensor unit comprises:
one or more Hall Effect sensors; and
one or more permanent magnets.

16. The device of claim 9 further comprising one or more device weight sensors for detecting any change of weight of the device and supplying a device weight signal to the microprocessor controller, wherein the device weight sensor is a strain gauge, a load cell, a force-sensing resistor or a combination thereof.

17. The device of claim 9 further comprising one or more presence sensors for detecting a presence or an absence of the animal and supplying one or more presence signals to the microprocessor controller, wherein the presence sensor is a microwave radar, an ultrasonic sensor, an infrared sensor, a camera, a thermal imaging sensor, a millimeter-wave radar, a laser sensor or a combination thereof.

18. The device of claim 9 further comprising one or more waste level gauges for detecting a level of waste accumulated in the receptacle and supplying one or more waste level signals to the microprocessor controller, wherein the waste level gauge is an infrared sensor, a laser sensor, a camera or a combination thereof.

19. A method for handling an animal waste deposited by an animal in a chamber and dumping the animal waste to a receptacle, wherein the chamber containing a litter material is rotatable about an axis of rotation and comprises a chamber opening and a partition, the method comprising the steps of:
providing, by the chamber opening, an ingress and an egress for the animal to deposit the animal waste when the chamber is in a first position;
rotating the chamber from the first position to a second position, the litter material passes through the screen sections and enters the trough, and the animal waste is kept out of the trough by the partition and dropped to the receptacle through the chamber opening by gravitational force;
rotating the chamber from the second position to a third position for reintroducing the litter material; and
rotating the chamber to the first position for leveling the litter material.

20. The method of claim 19 further comprising the step of:
determining, by a chamber weight sensor and a device weight sensor, a presence or an absence of the animal within the chamber;
determining, by a presence sensor, a presence or an absence of the animal within a predetermined distance from the chamber; and
detecting a waste level of the receptacle for stopping the rotation of the chamber when the receptacle is full.
